(19) United States
(12) Patent Application Publication
(10) Pub. No.: US 2021/0165081 A1
(43) Pub. Date: Jun. 3, 2021

(54) OPTICAL DEVICE AND PHOTODETECTION SYSTEM

(71) Applicant: Panasonic Intellectual Property Management Co., Ltd., Osaka (JP)

(72) Inventors: HIROYUKI TAKAGI, Osaka (JP); TAKU HIRASAWA, Kyoto (JP); AKIRA HASHIYA, Osaka (JP); YASUHISA INADA, Osaka (JP)

(21) Appl. No.: 17/154,402

(22) Filed: Jan. 21, 2021

Related U.S. Application Data
(63) Continuation of application No. PCT/JP2019/031099, filed on Aug. 7, 2019.

(30) Foreign Application Priority Data
Oct. 23, 2018 (JP) 2018-199107

(51) Int. Cl. G01S 7/481; G01S 17/42; G01S 17/89

(52) U.S. Cl. CPC G01S 7/4817; G01S 17/89; G01S 17/42; G01S 7/4818

(57) ABSTRACT

An optical device includes a first mirror, a second mirror facing the first mirror, an optical waveguide layer, located between the first mirror and the second mirror, that contains a material whose refractive index changes when a voltage is applied, first and second electrodes directly or indirectly holding the optical waveguide layer therebetween, the first electrode including a plurality of electrode sections arranged in a first direction, and a control circuit. The light is emitted via the first mirror from the optical waveguide layer, or the light is taken into the optical waveguide layer via the first mirror.

### BACKGROUND

### 1. Technical Field

The present disclosure relates to an optical device and a photodetection system.

### 2. Description of the Related Art

There have conventionally been proposed various types of device that are capable of scanning space with light.

International Publication No. 2013/168266 and U.S. Patent Application Publication No, 2016/0245903 each disclose a configuration in which an optical scan can be performed with a mirror-rotating driving apparatus.

Japanese Unexamined Patent Application Publication (Translation of PCT Application) No. 2016-508235 discloses an optical phased array having a plurality of two-dimensionally arrayed nanophotonic antenna elements. Each antenna element is optically coupled to a variable optical delay line (i.e. a phase shifter). In this optical phased array, a coherent light beam is guided to each antenna element by an optical waveguide, and the phase of the light beam is shifted by the phase shifter. This makes it possible to vary the amplitude distribution of a far-field radiating pattern.

Japanese Unexamined Patent Application Publication No. 2013-16591 discloses an optical deflection element including: an optical waveguide including an optical waveguide layer through the inside of which light is guided and first distributed Bragg reflectors formed on upper and lower surfaces, respectively, of the optical waveguide layer; a light entrance through which light enters the optical waveguide, and a light exit formed on a surface of the optical waveguide to let out light having entered through the light entrance and being guided through the inside of the optical waveguide.

### SUMMARY

One non-limiting and exemplary embodiment provides a novel optical device that is capable of achieving an optical scan through a comparatively simple configuration.

In one general aspect, the techniques disclosed here feature an optical device including: a first mirror extending in a first direction; a second mirror facing the first mirror and extending in the first direction; an optical waveguide layer, located between the first mirror and the second mirror, that propagates light along the first direction and that contains a material whose refractive index changes when a voltage is applied; first and second electrodes directly or indirectly holding the optical waveguide layer therebetween, the first electrode including a plurality of electrode sections arranged in the first direction; and a control circuit that controls a voltage that is applied between each of the plurality of electrode sections of the first electrode and the second electrode. The light is emitted via the first mirror from the optical waveguide layer, or the light is taken into the optical waveguide layer via the first mirror.

It should be noted that general or specific embodiments may be implemented as a device, a system, a method, or any selective combination thereof.

An aspect of the present disclosure makes it possible to achieve an optical one-dimensional scan or two-dimensional scan through a comparatively simple configuration.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a perspective view schematically showing a configuration of an optical scan device according to an exemplary embodiment of the present disclosure;

FIG. 2 is a diagram schematically showing an example of a cross-section structure of one optical waveguide element and an example of propagating light;

FIG. 3A is a diagram showing a cross-section of an optical waveguide array that emits light in a direction perpendicular to an exit face of the optical waveguide array;

FIG. 3B is a diagram showing a cross-section of an optical waveguide array that emits light in a direction different from a direction perpendicular to an exit face of the optical waveguide array;

FIG. 4 is a perspective view schematically showing an optical waveguide array in a three-dimensional space;

FIG. 5 is a schematic view of an optical waveguide array and a phase shifter array as seen from a direction (Z direction) normal to a light exit face;

FIG. 6A is a diagram schematically showing an example of an optical device fabricated by bonding a lower structure and an upper structure together;

FIG. 6B is a diagram schematically showing examples of spots of light that are emitted from the optical device;

FIG. 7 is a diagram schematically showing an example of an optical device according to Embodiment 1;

FIG. 8A is a diagram showing a relationship between the thickness of an optical waveguide layer and an angle of emission;

FIG. 8B is a diagram showing a relationship between the refractive index of the optical waveguide layer and the angle of emission;

FIG. 9 is a flow chart of operation of a control circuit;

FIG. 10 is a diagram schematically showing a modification of the optical device shown in FIG. 7;

FIG. 11A is a diagram schematically showing an example of an arrangement of a plurality of electrode sections in an XY plane;

FIG. 11B is a diagram schematically showing an example of an arrangement of a plurality of electrode sections in the XY plane;

FIG. 11C is a diagram schematically showing an example of an arrangement of a plurality of electrode sections in the XY plane;

FIG. 11D is a diagram schematically showing an example of an arrangement of a plurality of electrode sections in the XY plane;

FIG. 12 is a diagram showing an example configuration of an optical scan device in which elements such as an optical divider, an optical waveguide array, a phase shifter array, and a light source are integrated on a circuit board;

FIG. 13 is a schematic view showing how a two-dimensional scan is being executed by irradiating a distant place with a light beam such as a laser from the optical scan device; and

FIG. 14 is a block diagram showing an example configuration of a LiDAR system that is capable of generating a ranging image.

### DETAILED DESCRIPTION

Prior to a description of embodiments of the present disclosure, underlying knowledge forming the basis of the present disclosure is described.

The inventors found that a conventional optical scan device has difficulty in scanning space with light without making a complex apparatus configuration.

For example, the technology disclosed in International Publication No. 2013/168266 requires a mirror-rotating driving apparatus. This undesirably makes a complex apparatus configuration that is not robust against vibration.

In the optical phased array described in Japanese Unexamined Patent Application Publication (Translation of PCT Application) No. 2016-508235, it is necessary to divide light into lights, introduce the lights into a plurality of column waveguide and a plurality of row waveguides, and guide the lights to the plurality of two-dimensionally arrayed antenna elements. This results in very complex wiring of optical waveguides through which to guide the lights. This also makes it impossible to attain a great two-dimensional scanning range. Furthermore, to two-dimensionally vary the amplitude distribution of emitted light in a far field, it is necessary to connect phase shifters separately to each of the plurality of two-dimensionally arrayed antenna elements and attach phase-controlling wires to the phase shifters. This causes the phases of lights falling on the plurality of two-dimensionally arrayed antenna elements to vary by a different amount. This makes the elements very complex in configuration.

The inventors focused on the foregoing problems in the conventional technologies and studied configurations to solve these problems. The inventors found that the foregoing problems can be solved by using an optical waveguide element having a pair of mirrors facing each other and an optical waveguide layer sandwiched between the mirrors. One of the pair of mirrors of the optical waveguide element has a higher light transmittance than the other and lets out a portion of light propagating through the optical waveguide layer. As will be mentioned later, the direction of light emitted (or the angle of emission) can be changed by adjusting the refractive index or thickness of the optical waveguide layer or the wavelength of light that is inputted to the optical waveguide layer. More specifically, by changing the refractive index, the thickness, or the wavelength, a component constituting the wave number vector (wave vector) of the emitted light and acting in a direction along a lengthwise direction of the optical waveguide layer can be changed, This allows a one-dimensional scan to be achieved.

Furthermore, in a case where an array of a plurality of the optical waveguide elements is used, a two-dimensional scan can be achieved. More specifically, a direction in which lights going out from the plurality of optical waveguide elements reinforce each other can be changed by giving an appropriate phase difference to lights that are supplied to the plurality of optical waveguide elements and adjusting the phase difference. A change in phase difference brings about a change in a component constituting the wave number vector of the emitted light and acting in a direction that intersects the direction along the lengthwise direction of the optical waveguide layer. This makes it possible to achieve a two-dimensional scan. Even in a case where a two-dimensional scan is performed, it is not necessary to cause the refractive index or thickness of each of a plurality of the optical waveguide layers or the wavelength of light to vary by a different amount. That is, a two-dimensional scan can be performed by giving an appropriate phase difference to lights that are supplied to the plurality of optical waveguide layers and causing at least one of the refractive index of each of the plurality of optical waveguide layers, the thickness of each of the plurality of optical waveguide layers, or the wavelength to vary by the same amount in synchronization. In this way, an embodiment of the present disclosure makes it possible to achieve an optical two-dimensional scanning through a comparatively simple configuration.

The phrase at least one of the refractive index, the thickness, or the “wavelength” herein means at least one selected from the group consisting of the refractive index of an optical waveguide layer, the thickness of an optical waveguide layer, and the wavelength of light that is inputted to an optical waveguide layer. For a change in direction of emission of light, any one of the refractive index, the thickness, and the wavelength may be controlled alone. Alternatively, the direction of emission of light may be changed by controlling any two or all of these three. In each of the following embodiments, the wavelength of light that is inputted to the optical waveguide layer may be controlled instead of or in addition to controlling the refractive index or the thickness.

The foregoing fundamental principles are similarly applicable to uses in which optical signals are received as well as uses in which light is emitted. The direction of light that can be received can be one-dimensionally changed by changing at least one of the refractive index, the thickness, or the wavelength. Furthermore, the direction of light that can be received can be two-dimensionally changed by changing a phase difference of light through a plurality of phase shifters connected separately to each of a plurality of unidirectionally-arrayed optical waveguide elements.

An optical scan device and an optical receiver device according to an embodiment of the present disclosure may be used, for example, as an antenna in a photodetection system such as a LiDAR (light detection and raging) system. The LiDAR system, which involves the use of short-wavelength electromagnetic waves (visible light, infrared radiation, or ultraviolet radiation), can detect a distance distribution of objects with higher resolution than a radar system that involves the use of radio waves such as millimeter waves. Such a LiDAR system is mounted, for example, on a movable body such as an automobile, a UAV (unmanned aerial vehicle, i.e. a drone), or an AGV (automated guided vehicle), and may be used as one of the crash avoidance technologies. The optical scan device and the optical receiver device are herein sometimes collectively referred to as “optical device”. Further, a device that is used in the optical scan device or the optical receiver device is sometimes referred to as “optical device”, too.

The phrase “shape of a light beam” herein means the “shape and/or spread angle of a light beam”.

### Example Configuration of Optical Scan Device

The following describes, as an example, a configuration of an optical scan device that performs a two-dimensional scan. Note, however, that an unnecessarily detailed description may be omitted. For example, a detailed description of a matter that is already well known and a repeated description of substantially the same configuration may be omitted. This is intended to facilitate understanding of persons skilled in the art by avoiding making the following description unnecessarily redundant. It should be noted that the inventors provide the accompanying drawings and the following description for persons skilled in the art to fully understand the present disclosure and do not intend to limit the subject matter recited in the claims. In the following description, identical or similar constituent elements are given the same reference numerals.

In the present disclosure, the term “light” means electromagnetic waves including ultraviolet radiation (ranging from approximately 10 nm to approximately 400 nm in wavelength) and infrared radiation (ranging from approximately 700 nm to approximately 1 mm in wavelength) as well as visible light (ranging approximately 400 nm to approximately 700 nm in wavelength). Ultraviolet radiation is herein sometimes referred to as “ultraviolet light”, and infrared radiation is herein sometimes referred to as “infrared light”.

In the present disclosure, an optical “scan” means changing the direction of light. A “one-dimensional scan” means changing the direction of light along a direction that intersects the direction. A “two-dimensional scan” means two-dimensionally changing the direction of light along a plane that intersects the direction.

When it is said herein that two directions are “parallel” to each other, it not only means that they are strictly parallel to each other but also encompasses a configuration in which they form an angle of 15 degrees or smaller. When it is said herein that two directions are “perpendicular” to each other, it does not mean that they are strictly perpendicular to each other but encompasses a configuration in which they form an angle of 75 degrees or larger and 105 degrees or smaller.

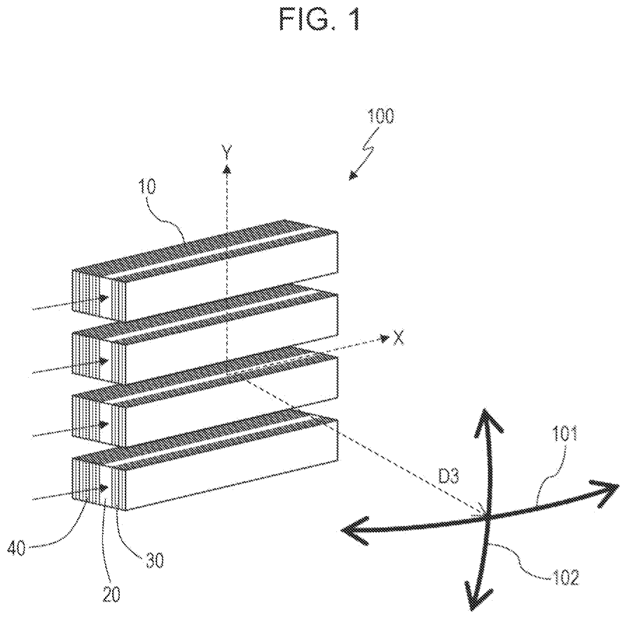

FIG. 1 is a perspective view schematically showing a configuration of an optical scan device 100 according to an exemplary embodiment of the present disclosure. The optical scan device 100 includes an optical waveguide array including a plurality of optical waveguide elements 10. Each of the plurality of optical waveguide elements 10 has a shape extending in a first direction (in FIG. 1, an X direction). The plurality of optical waveguide elements 10 are regularly arrayed in a second direction (in FIG. 1, a Y direction) that intersects the first direction. The plurality of optical waveguide elements 10, while propagating light in the first direction, emit the light in a third direction D3 that intersects an imaginary plane parallel to the first and second directions. Although, in the present embodiment, the first direction (X direction) and the second direction (Y direction) are orthogonal to each other, they do not need to be orthogonal to each other. Although, in the present embodiment, the plurality of optical waveguide elements 10 are placed at equal spacings in the Y direction, they do not necessarily need to be arranged at equal spacings.

R should be noted that the orientation of a structure shown in a drawing of the present disclosure is set in view of understandability of explanation and is in no way intended to restrict the orientation in which an embodiment of the present disclosure is carried out in actuality. Further, the shape and size of the whole or a part of a structure shown in a drawing are not intended to restrict an actual shape and size.

Each of the plurality of optical waveguide elements 10 has first and second mirrors 30 and 40 (each hereinafter sometimes referred to simply as “mirror”) facing each other and an optical waveguide layer 20 located between the mirror 30 and the mirror 40. Each of the mirrors 30 and 40 has a specular surface, situated at the interface with the optical waveguide layer 20, that intersects the third direction D3. The mirror 30, the mirror 40, and the optical waveguide layer 20 have shapes extending in the first direction (X direction).

A plurality of the first mirrors 30 of the plurality of optical waveguide elements 10 may be a plurality of portions of a mirror of integral construction. Further, a plurality of the second mirrors 40 of the plurality of optical waveguide elements 10 may be a plurality of portions of a mirror of integral construction, Furthermore, a plurality of the optical waveguide layers 20 of the plurality of optical waveguide elements 10 may be a plurality of portions of an optical waveguide layer of integral construction. A plurality of optical waveguides can be formed by at least (1) each first mirror 30 being constructed separately from another first mirror 30, (2) each second mirror 40 being constructed separately from another second mirror 40, or (3) each optical waveguide layer 20 being constructed separately from another optical waveguide layer 20. The phrase “being constructed separately” encompasses not only physically providing space but also separating first mirrors 30, second mirrors 40, or optical waveguide layers 20 from each other by placing a material of a different refractive index between them.

The specular surface of the first mirror 30 and the specular surface of the second mirror 40 face each other substantially in a parallel fashion, Of the two mirrors 30 and 40, at least the first mirror 30 has the property of transmitting a portion of light propagating through the optical waveguide layer 30. In other words, the first mirror 30 has a higher light transmittance against the light than the second mirror 40. For this reason, a portion of light propagating through the optical waveguide layer 20 is emitted outward from the first mirror 30. Such mirrors 30 and 40 may for example be multilayer mirrors that are formed by multilayer films of dielectrics (sometimes referred to as “multilayer reflective films”).

An optical two-dimensional scan can be achieved by controlling the phases of lights that are inputted to the respective optical waveguide elements 10 and, furthermore, causing the refractive indices or thicknesses of the optical waveguide layers 20 of these optical waveguide elements 10 or the wavelengths of lights that are inputted to the optical waveguide layers 20 to simultaneously change in synchronization.

In order to achieve such a two-dimensional scan, the inventors conducted an analysis on the principle of operation of an optical waveguide element 10. As a result of their analysis, the inventors succeeded in achieving an optical two-dimensional scan by driving a plurality of optical waveguide elements 10 in synchronization.

As shown in FIG. 1, inputting light to each optical waveguide element 10 causes light to exit the optical waveguide element 10 through an exit surface of the optical waveguide element 10. The exit face is located on the side opposite to the specular surface of the first mirror 30. The direction D3 of the emitted light depends on the refractive index and thickness of the optical waveguide layer and the wavelength of light. In the present embodiment, at least one of the refractive index of each optical waveguide layer, the thickness of each optical waveguide layer, or the wavelength is controlled in synchronization so that lights that are emitted separately from each optical waveguide element 10 are oriented in substantially the same direction. This makes it possible to change X-direction components of the wave number vectors of lights that are emitted from the plurality of optical waveguide elements 10. In other words, this makes it possible to change the direction D3 of the emitted light along a direction 101 shown in FIG. 1.

Furthermore, since the lights that are emitted from the plurality of optical waveguide elements 10 are oriented in the same direction, the emitted lights interfere with one another. By controlling the phases of the lights that are emitted from the respective optical waveguide elements 10, a direction in which the lights reinforce one another by interference can be changed. For example, in a case where a plurality of optical waveguide elements 10 of the same size are placed at equal spacings in the Y direction, lights differing in phase by a constant amount from one another are inputted to the plurality of optical waveguide elements 10. By changing the phase differences, Y-direction components of the wave number vectors of the emitted lights can be changed. In other words, by varying phase differences among lights that are introduced into the plurality of optical waveguide elements 10, the direction D3, in which the emitted lights reinforce one another by interference, can be changed along a direction 102 shown in FIG. 1, This makes it possible to achieve an optical two-dimensional scan.

The following describes the principle of operation of the optical scan device 100.

### Principle of Operation of Optical Waveguide Element

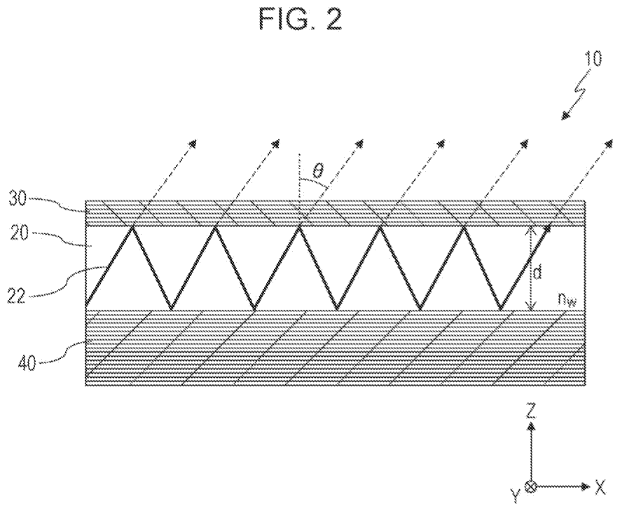

FIG. 2 is a diagram schematically showing an example of a cross-section structure of one optical waveguide element 10 and an example of propagating light. With a Z direction being a direction perpendicular of the X and Y directions shown in FIG. 1, FIG. 2 schematically shows a cross-section parallel to an XZ plane of the optical waveguide element 10, The optical waveguide element 10 is configured such that the pair of mirrors 30 and 40 are disposed so as to hold the optical waveguide layer 20 therebetween. Light 22 introduced into the optical waveguide layer 20 through one end of the optical waveguide layer 20 in the X direction propagates through the inside of the optical waveguide layer 20 while being repeatedly reflected by the first mirror 30 provided on an upper surface (in FIG. 2, the upper side) of the optical waveguide layer 20 and the second mirror 40 provided on a lower surface (in FIG. 2, the lower side) of the optical waveguide layer 20. The light transmittance of the first mirror 30 is higher than the light transmittance of the second mirror 40. For this reason, a portion of the light can be outputted mainly from the first mirror 30.

In the case of an optical waveguide such as an ordinary optical fiber, light propagates along the optical waveguide while repeating total reflection. On the other hand, in the case of an optical waveguide element 10 according to the present embodiment, light propagates while being repeatedly reflected by the mirrors 30 and 40 disposed above and below, respectively, the optical waveguide layer 20. For this reason, there are no restrictions on angles of propagation of light. The term “angle of propagation of light” here means an angle of incidence on the interface between the mirror 30 or 40 and the optical waveguide layer 20. Light falling on the mirror 30 or 40 at an angle that is closer to the perpendicular can be propagated, too. That is, light falling on the interface at an angle that is smaller than a critical angle of total reflection can be propagated, too. This causes the group speed of light in the direction of propagation of light to be much lower than the speed of light in free space. For this reason, the optical waveguide element 10 has such a property that conditions for propagation of light vary greatly according to changes in the wavelength of light, the thickness of the optical waveguide layer 20, and the refractive index of the optical waveguide layer 20. Such an optical waveguide is referred to as “reflective optical waveguide” or “slow light optical waveguide”.

The angle of emission θ of light that is emitted into the air from the optical waveguide element 10 is expressed by Formula (1) as follows:

$$sin θ = \sqrt{{n}_{w}^{2} - {( \frac{m λ}{2 d} )}^{2}} \qquad ( 1 )$$

As can be seen from Formula (1), the direction of emission of light can be changed by changing any of the wavelength λ of light in the air, the refractive index n_{w} of the optical waveguide layer 20, and the thickness d of the optical waveguide layer 20.

For example, in a case where n_{w}=2, d=387 nm, λ=1550 nm, and m=1, the angle of emission is 0 degree. Changing the refractive index from this state to n_{w}=2.2 changes the angle of emission to approximately 66 degrees. Meanwhile, changing the thickness to d=420 nm without changing the refractive index changes the angle of emission to approximately 51 degrees. Changing the wavelength to λ=1500 nm without changing the refractive index or the thickness changes the angle of emission to approximately 30 degrees. In this way, the direction of emission of light can be greatly changed by changing any of the wavelength of light the refractive index n_{w} of the optical waveguide layer 20, and the thickness d of the optical waveguide layer 20.

Accordingly, the optical scan device 100 according to the embodiment of the present disclosure controls the direction of emission of light by controlling at least one of the wavelength λ of light that is inputted to each of the optical waveguide layers 20, the refractive index n_{w} of each of the optical waveguide layers 20, or the thickness d of each of the optical waveguide layers 20, The wavelength λ of light may be kept constant without being changed during operation. In that case, an optical scan can be achieved through a simpler configuration. The wavelength is not limited to a particular wavelength. For example, the wavelength λ may be included in a wavelength range of 400 nm to 1100 nm (from visible light to near-infrared light) within which high detection sensitivity is attained by a common photodetector or image sensor that detects light by absorbing light through silicon (Si), In another example, the wavelength λ may be included in a near-infrared wavelength range of 1260 nm to 1625 nm within which an optical fiber or a Si optical waveguide has a comparatively small transmission loss. It should be noted that these wavelength ranges are merely examples. A wavelength range of light that is used is not limited to a wavelength range of visible light or infrared light but may for example be a wavelength range of ultraviolet light.

In order to change the direction of emitted light, the optical scan device 100 may include a first adjusting element that changes at least one of the refractive index of the optical waveguide layer 20 of each optical waveguide element 10, the thickness of the optical waveguide layer 20 of each optical waveguide element 10, or the wavelength.

As stated above, using an optical waveguide element 10 makes it possible to greatly change the direction of emission of light by changing at least one of the refractive index n_{w} of the optical waveguide layer 20, the thickness d of the optical waveguide layer 20, or the wavelength λ. This makes it possible to change, to a direction along the optical waveguide element 10, the angle of emission of light that is emitted from the mirror 30, By using at least one optical waveguide element 10, such a one-dimensional scan can be achieved.

In order to adjust the refractive index of at least a part of the optical waveguide layer 20, the optical waveguide layer 20 may contain a liquid crystal material or an electro-optical material. The optical waveguide layer 20 may be sandwiched between a pair of electrodes. By applying a voltage to the pair of electrodes, the refractive index of the optical waveguide layer 20 can be changed.

In order to adjust the thickness of the optical waveguide layer 20, at least one actuator may be connected, for example, to at least either the first mirror 30 or the second mirror 40. The thickness of the optical waveguide layer 20 can be changed by varying the distance between the first mirror 30 and the second mirror 40 through the at least one actuator. When the optical waveguide layer 20 is formed from liquid, the thickness of the optical waveguide layer 20 may easily change.

### Principle of Operation of Two-Dimensional Scan

In an optical waveguide array in which a plurality of optical waveguide elements 10 are unidirectionally arrayed, the interference of lights that are emitted from the respective optical waveguide elements 10 brings about a change in direction of emission of light. By adjusting the phases of lights that are supplied separately to each optical waveguide element 10, the direction of emission of light can be changed. The following describes the principles on which it is based.

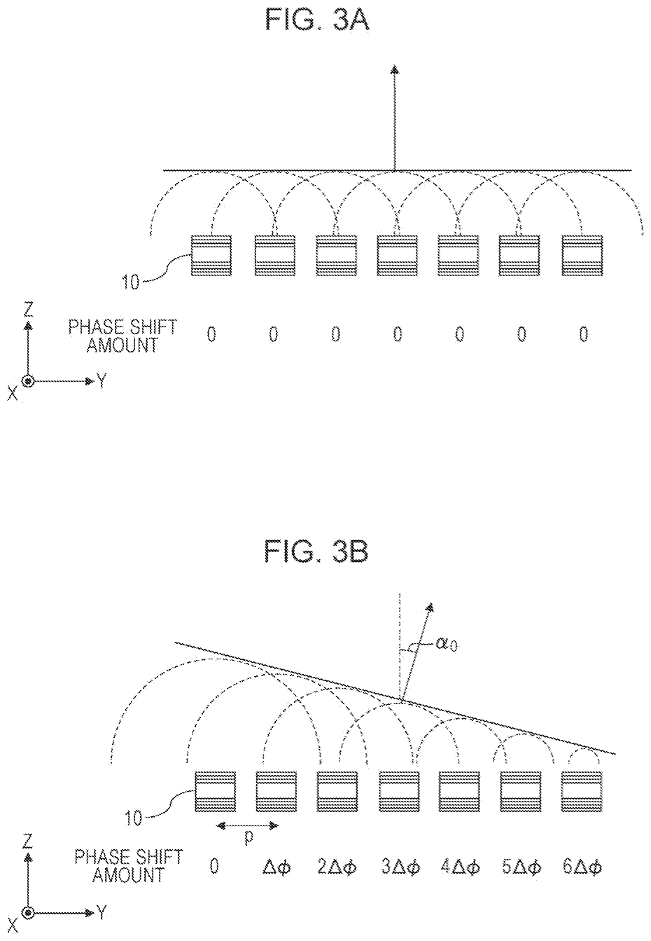

FIG. 3A is a diagram showing a cross-section of an optical waveguide array that emits light in a direction perpendicular to an exit face of the optical waveguide array. FIG. 3A also describes the phase shift amounts of lights that propagate separately through each optical waveguide element 10. Note here that the phase shift amounts are values based on the phase of the light that propagates through the leftmost optical waveguide element 10. The optical waveguide array according to the present embodiment includes a plurality of optical waveguide elements 10 arrayed at equal spacings. In FIG. 3A, the dashed circular arcs indicate the wave fronts of lights that are emitted separately from each optical waveguide element 10. The straight line indicates a wave front that is formed by the interference of the lights. The arrow indicates the direction of light that is emitted from the optical waveguide array (i.e. the direction of a wave number vector). In the example shown in FIG. 3A, lights propagating through the optical waveguide layers 20 of each separate optical waveguide element 10 are identical in phase to one another. In this case, the light is emitted in a direction (Z direction) perpendicular to both an array direction (Y direction) of the optical waveguide elements 10 and a direction (X direction) in which the optical waveguide layers 20 extend.

FIG. 3B is a diagram showing a cross-section of an optical waveguide array that emits light in a direction different from a direction perpendicular to an exit face of the optical waveguide array. In the example shown in FIG. 3B, lights propagating through the optical waveguide layers 20 of the plurality of optical waveguide elements 10 differ in phase from one another by a constant amount (Δφ) in the array direction. In this case, the light is emitted in a direction different from the Z direction. By varying Δφ), a Y-direction component of the wave number vector of the light can be changed. Assuming that p is the center-to-center distance between two adjacent optical waveguide elements 10, the angle of emission α₀ of light is expressed by Formula (2) as follows:

$$sin {α}_{0} = \frac{Δφλ}{2 π p} \qquad ( 2 )$$

In the example shown in FIG. 2, the direction of emission of light is parallel to the XZ plane. That is, α₀=0°. In each of the examples shown in FIGS. 3A and 3B, the direction of light that is emitted from the optical scan device 100 is parallel to a YZ plane. That is, θ=0°. However, in general, the direction of light that is emitted from the optical scan device 100 is not parallel to the XZ plane or the YZ plane. That is, θ≠0° and α₀≠0.

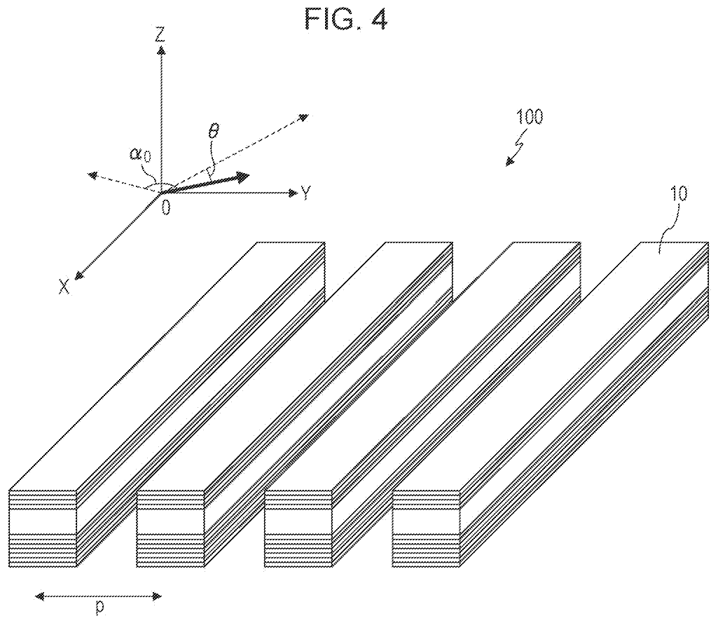

FIG. 4 is a perspective view schematically showing an optical waveguide array in a three-dimensional space. The bold arrow shown in FIG. 4 represents the direction of light that is emitted from the optical scan device 100. θ is the angle formed by the direction of emission of light and the YZ plane. θ satisfies Formula (1). CLO is the angle formed by the direction of emission of light and the XZ plane. α₀ satisfies Formula (2).

### Phase Control of Light That is Introduced Into Optical Waveguide Array

In order to control the phases of lights that are emitted from the respective optical waveguide elements 10, a phase shifter that changes the phase of light may be provided, for example, at a stage prior to the introduction of light into an optical waveguide element 10. The optical scan device 100 according to the present embodiment includes a plurality of phase shifters connected separately to each of the plurality of optical waveguide elements 10 and a second adjusting element that adjusts the phases of lights that propagate separately through each phase shifter. Each phase shifter includes an optical waveguide joined either directly or via another optical waveguide to the optical waveguide layer 20 of a corresponding one of the plurality of optical waveguide elements 10. The second adjusting element varies differences in phase among lights propagating from the plurality of phase shifters to the plurality of optical waveguide elements 10 and thereby changes the direction (i.e, the third direction D3) of light that is emitted from the plurality of optical waveguide elements 10. As is the case with the optical waveguide array, a plurality of arrayed phase shifters are hereinafter sometimes referred to as “phase shifter array”.

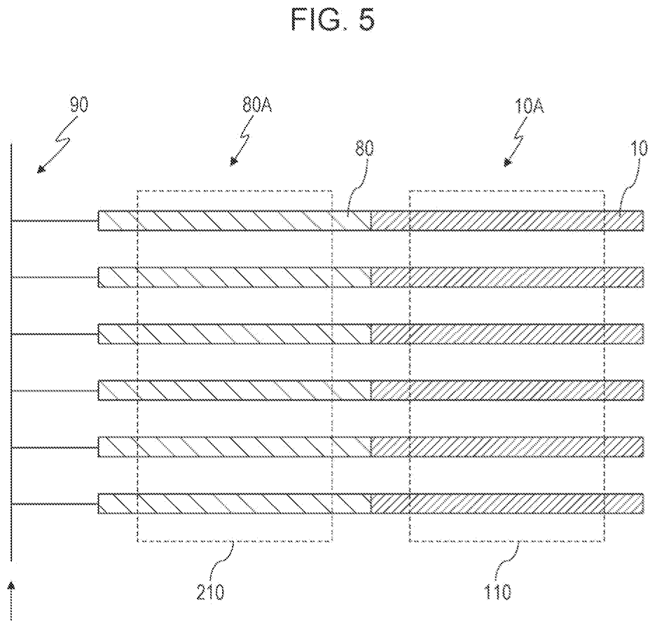

FIG. 5 is a schematic view of an optical waveguide array 10A and a phase shifter array 80A as seen from a direction (Z direction) normal to a light exit face. In the example shown in FIG. 5, all phase shifters 80 have the same propagation characteristics, and all optical waveguide elements 10 have the same propagation characteristics. The phase shifter 80 and the optical waveguide elements 10 may be the same in length or may be different in length. In a case where the phase shifters 80 are equal in length, the respective phase shift amounts can be adjusted, for example, by a driving voltage, Further, by making a structure in which the lengths of the phase shifters 80 vary in equal steps, phase shifts can be given in equal steps by the same driving voltage. Furthermore, this optical scan device 100 further includes an optical divider 90 that divides light into lights and supplies the lights to the plurality of phase shifters 80, a first driving circuit 110 that drives each optical waveguide element 10, and a second driving circuit 210 that drives each phase shifter 80. The straight arrow shown in FIG. 5 indicates the inputting of light. A two-dimensional scan can be achieved by independently controlling the first driving circuit 110 and the second driving circuit 210, which are separately provided. In this example, the first driving circuit 110 functions as one element of the first adjusting element, and the second driving circuit 210 functions as one element of the second adjusting element,

The first driving circuit 110 changes at least either the refractive index or thickness of the optical waveguide layer 20 of each optical waveguide element 10 and thereby changes the angle of light that is emitted from the optical waveguide layer 20. The second driving circuit 210 changes the refractive index of the optical waveguide 20a of each phase shifter 80 and thereby changes the phase of light that propagates through the inside of the optical waveguide 20a. The optical divider 90 may be constituted by an optical waveguide through which light propagates by total reflection or may be constituted by a reflective optical waveguide that is similar to an optical waveguide element 10.

The lights divided by the optical divider 90 may be introduced into the phase shifters 80 after the phases of the lights have been controlled, respectively. This phase control may involve the use of, for example, a passive phase control structure based on an adjustment of the lengths of optical waveguides leading to the phase shifters 80. Alternatively, it is possible to use phase shifters that are similar in function to the phase shifters 80 and that can be controlled by electrical signals. The phases may be adjusted by such a method prior to introduction into the phase shifters 80, for example, so that lights of equal phases are supplied to all phase shifters 80. Such an adjustment makes it possible to simplify the control of each phase shifter 80 by the second driving circuit 210.

An optical device that is similar in configuration to the aforementioned optical scan device 100 can also be utilized as an optical receiver device. Details of the principle of operation of the optical device, a method of operation of the optical device, and the like are disclosed in U.S. Patent Application Publication No. 2018/0224709, the disclosure of which is hereby incorporated by reference herein in its entirety.

### Uneven Thickness of Optical Waveguide Layer

The optical device 100 may be fabricated, for example, by bonding a lower structure and an upper structure together.

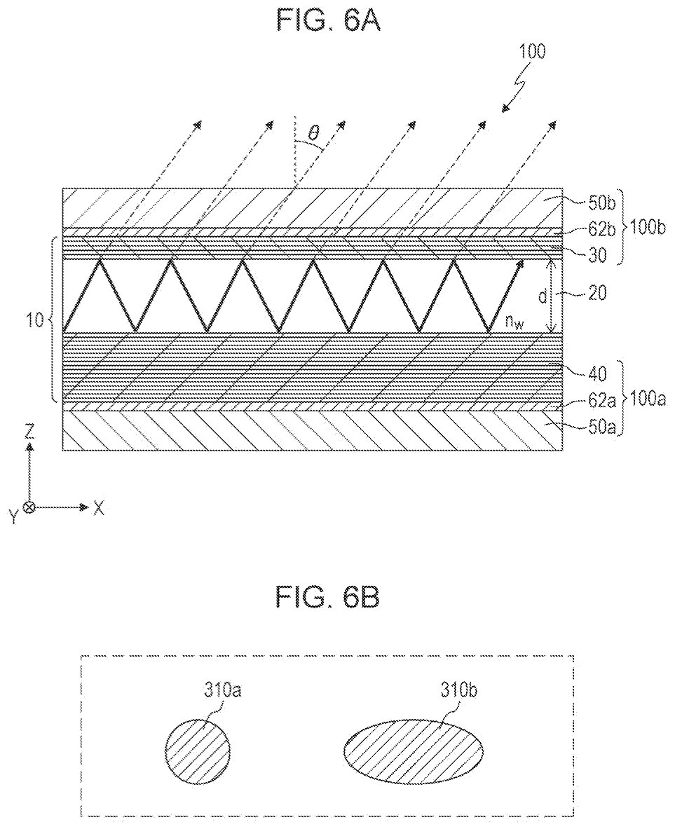

FIG. 6A is a diagram schematically showing an example of an optical device 100 fabricated by bonding a lower structure 100a and an upper structure 100b together. The lower structure 100a includes a substrate 50a, an electrode 62a on the substrate 50a, and a mirror 40 on the electrode 62a. The upper structure 100b includes a substrate 50b, an electrode 62b on the substrate 50b, and a mirror 40 on the electrode 62b. The optical device 100 shown in FIG. 6A may be fabricated by bonding the lower structure 100a and the upper structure 100b together via a supporting member (not illustrated). An optical waveguide element 10 of the optical device 100 includes the mirror 30, the mirror 40, and an optical waveguide layer 20. A portion of light propagating through the optical waveguide layer 20 along the X direction is emitted via the upper structure 100b.

The optical waveguide layer 20 may contain a material whose refractive index changes when a voltage is applied. The optical waveguide layer 20 contains for example a liquid crystal material or an electro-optical material. By applying a voltage to a pair of the electrodes 62a and 62b, the refractive index n_{w} 1of the optical waveguide layer 20 can be changed, This makes it possible to change the angle of emission of light that is emitted from the optical device 100.

The inventors found that the following problem arises in a case where the optical device 100 is manufactured by bonding the lower structure 100a and the upper structure 100b together. A manufacturing error or warpage of at least either the substrate 50a or the substrate 50b may prevent the mirror 30 and the mirror 40 from being parallel to each other. In this case, the thickness d of the optical waveguide layer 20 becomes uneven. For this reason, the angle of emission of light that is emitted from the optical device 100 may become uneven. This may result in the spread of the spot size of the emitted light.

FIG. 6B is a diagram schematically showing examples of spots of light that are emitted from the optical device 100. The drawing on the left of FIG. 6B shows a spot 310a of light that is formed when the thickness d of the optical waveguide layer 20 is even. The drawing on the right of FIG. 6B shows a spot 310b of light that is formed when the thickness d of the optical waveguide layer 20 is uneven. As shown in FIG. 6B, when the thickness d of the optical waveguide layer 20 is uneven, the spot of light spreads and the spot size of light does not become minimized. This may cause a decrease in the intensity of light that is emitted from the optical device 100. This results in difficulty in scanning a physical object in a far field.

Based on the foregoing study, the inventors conceived optical devices described in the following items,

An optical device according to a first item includes: a first mirror extending in a first direction; a second mirror facing the first mirror and extending in the first direction; an optical waveguide layer, located between the first mirror and the second mirror, that propagates light along the first direction and that contains a material whose refractive index changes when a voltage is applied; first and second electrodes directly or indirectly holding the optical waveguide layer therebetween, the first electrode including a plurality of electrode sections arranged in the first direction; and a control circuit that controls a voltage that is applied between each of the plurality of electrode sections of the first electrode and the second electrode. The light is emitted via the first mirror from the optical waveguide layer, or the light is taken into the optical waveguide layer via the first mirror, A light transmittance of the first mirror may be higher than a light transmittance of the second mirror.

This optical device makes it possible to, by controlling the voltage that is applied between each of the plurality of electrode sections of the first electrode and the second electrode, independently control lights that are emitted from a plurality of portions of the optical waveguide layer that overlap the plurality of electrode sections, respectively, when seen from a direction perpendicular to the first mirror.

An optical device according to a second item is directed to the optical device according to the first item, wherein the control circuit sets a value of the voltage that is applied between each of the plurality of electrode sections and the second electrode to such a value that lights are emitted at an identical angle of emission from a plurality of portions of the optical waveguide layer that overlap the plurality of electrode sections, respectively, when seen from a direction perpendicular to the first mirror.

This optical device makes it possible to minimize the spread of a spot of emitted light.

An optical device according to a third item is directed to the optical device according to the first item, wherein when it is assumed that n_{wk} is a refractive index of a portion of the optical waveguide layer that overlaps a kth (where k is an integer of 2 or larger) electrode section of the plurality of electrode sections, dₖ is a thickness of the portion, λ is a wavelength in air of light propagating through the optical waveguide layer, and m is a mode number of light propagating through the optical waveguide layer, the control circuit sets a value of the voltage that is applied between each of the plurality of electrode sections and the second electrode to such a value that all of the plurality of portions of the optical waveguide layer become equal in (n_{wk})²−(mλ2dₖ)².

This optical device brings about the same effect as the optical device according to the second item,

An optical device according to a fourth item is directed to the optical device according to any of the first to third items, wherein the control circuit determines, with reference to data showing an angle of emission of light and the voltage that is applied between each of the plurality of electrode sections of the first electrode and the second electrode, a value of the voltage that is applied between each of the plurality of electrode sections of the first electrode and the second electrode.

This optical device makes it possible to easily determine, with reference to the data, the value of the voltage that is applied between each of the plurality of electrode sections of the first electrode and the second electrode.

An optical device according to a fifth item is directed to the optical device according to any of the first to fourth items, wherein the voltage that is applied between each of the plurality of electrode sections and the second electrode is a sum of a first voltage component and a second voltage component, the control circuit sets the first voltage component regardless of electrode section to a uniform value corresponding to an angle of emission of the light that is emitted via the first mirror, and the control circuit sets the second voltage component to a value corresponding to each of the plurality of portions of the optical waveguide layer.

This optical device determines the angle of emission of emitted light according to the first voltage component and adjusts the spread of a spot of emitted light according to the second voltage component.

An optical device according to a sixth item is directed to the optical device according to any of the first to fourth items, further including a temperature sensor. The control circuit sets the voltage that is applied between each of the plurality of electrode sections and the second electrode to a value corresponding to a temperature measured by the temperature sensor

This optical device makes it possible to reduce both changes in angle of emission resulting from temperature changes and the spread of a spot of emitted light.

An optical device according to a seventh item is directed to the optical device according to the first item, further including a third electrode facing the second electrode across the optical waveguide layer.

This optical device makes it possible not only to apply a voltage to the optical waveguide layer via the first electrode and the second electrode but also to apply a voltage to the optical waveguide layer via the second electrode and the third electrode.

An optical device according to an eighth item is directed to the optical device according to the seventh item, further including a temperature sensor. The control circuit sets a voltage that is applied between the second electrode and the third electrode to a value corresponding to a temperature measured by the temperature sensor.

This optical device makes it possible to, by applying a voltage between the second electrode and the third electrode, change the direction of emitted light and reduce both changes in angle of emission resulting from temperature changes and the spread of a spot of emitted light.

An optical device according to a ninth item is directed to the optical device according to any of the first to eighth items, wherein any two adjacent electrode sections of the plurality of electrode sections have overlaps with each other when seen from a position parallel to a surface of each electrode section and from a direction orthogonal to the first direction.

In this optical device, the optical waveguide layer, when seen from a position parallel to each electrode section and from a direction orthogonal to the first direction, has no portion to which no voltage is applied in the first direction, As a result, the influence of the gap between electrode portions can be curbed.

An optical device according to a tenth item is directed to the optical device according to any of the first to eighth items, wherein the plurality of electrode sections are arranged in the first direction and a second direction that intersects the first direction.

This optical device is effective in a case where the thickness of the optical waveguide layer is uneven not only in the first direction but also in the second direction.

An optical device according to an eleventh item is directed to the optical device according to any of the first to tenth items, wherein the optical waveguide layer contains a liquid crystal material or an electro-optical material,

This optical device makes it possible to adjust the direction of emitted light and the spread of a spot by applying the optical waveguide layer containing the liquid crystal material or the electro-optical material.

An optical device according to a twelfth item is directed to the optical device according to any of the first to eleventh items, wherein the control circuit controls the voltage that is applied between each of the plurality of electrode sections and the second electrode and thereby controls a direction and shape of the light that is emitted via the first mirror from the optical waveguide layer.

This optical device makes it possible to adjust, through the operation of the control circuit, the direction and shape of the light that is emitted via the first mirror.

An optical device according to a thirteenth item is directed to the optical device according to any of the first to twelfth items, further including a plurality of optical waveguide units, arrayed in a second direction that intersects the first direction, each of which includes the first mirror, the second mirror, the optical waveguide layer, and the first and second electrodes. Each of the plurality of optical waveguide units may include the control circuit.

This optical device emits light from the plurality of optical waveguide units arrayed in the second direction.

An optical device according to a fourteenth item is directed to the optical device according to the thirteenth item, further including a plurality of phase shifters, connected separately to each of the plurality of optical waveguide units, each of which includes an optical waveguide joined either directly or via another optical waveguide to the optical waveguide layer of a corresponding one of the plurality of optical waveguide units. A direction of the light that is emitted via the first mirror from the optical waveguide layer or a direction of incidence of the light that is taken into the optical waveguide layer via the first mirror is changed by varying differences in phase among lights passing through the plurality of phase shifters.

In this optical device, the plurality of phase shifters make it possible to change a component constituting the direction of the light that is emitted via the first mirror or the direction of incidence of the light that is taken into the optical waveguide layer via the first mirror and acting parallel to the second direction.

A photodetection system according to a fifteenth item includes: the optical device according to any of the first to fourteenth items; a photodetector that detects light emitted from the optical device and reflected from a physical object, and a signal processing circuit that generates distance distribution data on the basis of output from the photodetector.

This photodetection system makes it possible to generate distance distribution data on a physical object.

### Embodiment 1

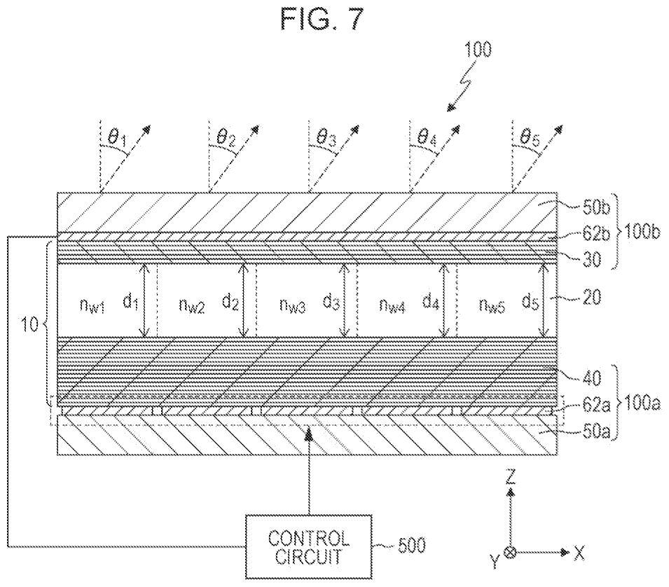

FIG. 7 is a diagram schematically showing an example of an optical device 100 according to the present embodiment. The optical device 100 according to the present embodiment includes a substrate 50a, a substrate 50b, a mirror 30, a mirror 40, an optical waveguide layer 20, electrodes 62a and 62b, and a control circuit 500.

The mirror 30 and the mirror 40 have structures extending in the X direction. The mirror 40 faces the mirror 30. The optical waveguide layer 20 is located between the mirror 30 and the mirror 40, and propagates light along the X direction. The light transmittance of the mirror 30 is higher than the light transmittance of the mirror 40. The optical device 100 according to the present embodiment is configured such that the light is emitted via the mirror 30 from the optical waveguide layer 30. As will be mentioned later, in a case where the optical device 100 is used as a receiver device, the light is taken into the optical waveguide layer 20 via the mirror 30.

The optical waveguide layer 20 contains a material whose refractive index changes when a voltage is applied. The optical waveguide layer 20 contains for example a liquid crystal material or an electro-optical material.

The liquid crystal material may for example be nematic liquid crystals. The molecular structure of a nematic liquid crystal is as follows:

R1-Ph1-R2-Ph2-R3

where R1 is any one member selected from the group consisting of an amino group, a carbonyl group, a carboxyl group, a cyano group, an amine group, a nitro group, a nitryl group, and an alkyl chain, R3 is any one member selected from the group consisting of an amino group, a carbonyl group, a carboxyl group, a cyano group, an amine group, a nitro group, a nitryl group, and an alkyl chain, Ph1 is an aromatic group such as a phenyl group or a biphenyl group, Ph2 is an aromatic group such as a phenyl group or a biphenyl group, and R2 is any one member selected from the group consisting of a vinyl group, a carbonyl group, a carboxyl group, a diazo group, and an azoxy group.

The liquid crystals are not limited to nematic liquid crystals. For example, smectic liquid crystals may be used. Among smectic liquid crystals, the liquid crystals may for example be in a smectic C phase (SmC phase). Among smectic C phases (SmC phases), the smectic liquid crystals may for example be in a chiral smectic phase (SmC* phase), i.e. ferroelectric liquid crystals each having a chiral center such as asymmetric carbon within a liquid crystal molecule.

The molecule structure of the SmC* phase is expressed as follows:

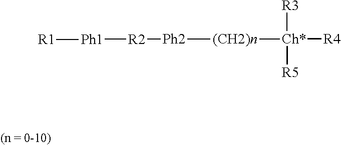

where R1 and R4 are each independently any one member selected from the group consisting of an amino group, a carbonyl group, a carboxyl group, a cyano group, an amine group, a nitro group, a nitryl group, and an alkyl chain, Ph1 is an aromatic group such as a phenyl group or a biphenyl group, Ph2 is an aromatic group such as a phenyl group or a biphenyl group, R2 is any one member selected from the group consisting of a vinyl group, a carbonyl group, a carboxyl group, a diazo group, and an azoxy group, Ch* is a chiral center, which is typically carbon (C*), R3 is any one member selected from the group consisting of hydrogen, a methyl group, an amino group, a carbonyl group, a carboxyl group, a cyano group, an amine group, a nitro group, a nitryl group, and an alkyl chain, R5 is any one member selected from the group consisting of hydrogen, a methyl group, an amino group, a carbonyl group, a carboxyl group, a cyano group, an amine group, a nitro group, a nitryl group, and an alkyl chain, and R3, R4, and R5 are functional groups that are different from one another.

The liquid crystal material may be a mixture of a plurality of liquid crystal molecules that are different in composition from each other. For example, a mixture of nematic liquid crystal molecules and smectic liquid crystal molecules may be used as the material of the optical waveguide layer 20.

The electro-optical material may be any of the following compounds:

| | |
|---|---|
| KDP (KH₂PO₄) crystal | For example, KDP, ADP (NH₄H₂PO₄), |
| | KDA (KH₂AsO₄), RDA (RbH₂PO₄), |
| | or ADA (NH₄H₂AsO₄) |
| Cubic system material | For example, KTN, BaTiO₃, SrTiO₃, |
| | Pb₃MgNb₂O₉, GaAs, CdTe, or InAs |
| Tetragonal system material | For example, LiNbO₃ or LiTaO₃ |
| Zinc blende material | For example, ZnS, ZnSe, ZnTe, GaAs, or |
| | CuCl |
| Tungsten bronze material | KLiNbO₃, SrBaNb₂O₆, KSrNbO, |
| | BaNaNbO, or Ca₂Nb₂O₇ |

The electrode 62a and the electrode 62b directly or indirectly hold the optical waveguide layer 20 therebetween, In the example shown in FIG. 7, the mirror 40 is located between the optical waveguide layer 20 and the electrode 62a, and the mirror 30 is located between the optical waveguide layer 20 and the electrode 62b. The electrode 62a is located on the substrate 50a, and the electrode 62b is located on the substrate 50b. The application of a voltage between the electrode 62a and the electrode 62b brings about a change in direction of the light that is emitted via the mirror 30 from the optical waveguide layer 20. In a case where the optical device 100 functions as a receiver device, the application of a voltage between the electrode 62a and the electrode 62b brings about a change in direction of the light that is taken into the optical waveguide layer 20 via the mirror 30. At least either the electrode 62a or the electrode 62b may be a transparent electrode formed from ITO or the like.

As previously mentioned, a manufacturing error or warpage of at least either the substrate 50a or the substrate 50b may prevent the mirror 30 and the mirror 40 from being parallel to each other, For example, the thickness of the optical waveguide layer 20 may gradually increase or decrease along the X direction, Alternatively, the thickness of the optical waveguide layer 20 may become thicker or thinner in a particular place. As can be seen from Formula (1), in a case where the thickness of the optical waveguide layer 20 is uneven, the angle of emission of the light that is emitted via the mirror 30 from the optical waveguide layer 20 becomes uneven, too. This may result in the spread of a spot of light that is emitted from the optical device 100.

To address this problem, the optical device 100 according to the present embodiment is configured such that at least either the electrode 62a or the electrode 62b is divided into a plurality of portions. The plurality of portions are hereinafter referred to as “plurality of electrode sections”. In the example shown in FIG. 7, the electrode 62a is divided into a plurality of electrode sections arranged in the X direction. The arrangement of the plurality of electrode sections will be described in detail later. The application of a voltage between each of the plurality of electrode sections of the electrode 62a and the electrode 62b makes it possible to adjust the refractive index of each of a plurality of portions of the optical waveguide layer 20 that overlap the plurality of electrode sections, respectively, of the electrode 62a when seen from the Z direction. This makes it possible to curb the influence of an uneven thickness of the optical waveguide layer 20 on the angle of emission of light that is emitted from the optical device 100. This results in a reduction in spread of a spot of emitted light.

The application of a voltage between each of the plurality of electrode sections of the electrode 62a and the electrode 62b is herein sometimes expressed as “application of a voltage to each of the plurality of electrode sections”. Furthermore, the plurality of portions of the optical waveguide layer 20 that overlap the plurality of electrode sections, respectively, of the electrode 62a when seen from the Z direction are sometimes referred to simply as “plurality of portions of the optical waveguide layer 20”.

In order to curb the influence of an uneven thickness of the optical waveguide layer 20, the control circuit 500 controls a voltage that is applied to each of the plurality of electrode sections. The following specifically describes how the control circuit 500 operates.

Assume that n_{wk} is the refractive index of the kth portion of the plurality of portions of the optical waveguide layer 20 as counted from an end in an −X direction and dₖ is the thickness of the kth portion. Note here that k is an integer of 2 or larger. A condition where lights that are emitted via the mirror 30 from the plurality of portions of the optical waveguide layer 20 are emitted at an identical angle of emission θ is obtained from Formula (1). This condition is that (n_{wk})²−(mλ/2dₖ)² is equal to sin²θ in all of the plurality of portions of the optical waveguide layer 20. Accordingly, in order for the condition to be satisfied, the control circuit 500 determines the value of the voltage that is applied to each of the plurality of electrode sections. In this way, the control circuit 500 applies, to each of the plurality of electrode sections, a voltage corresponding to the thickness of a corresponding one of the plurality of portions of the optical waveguide layer 20.

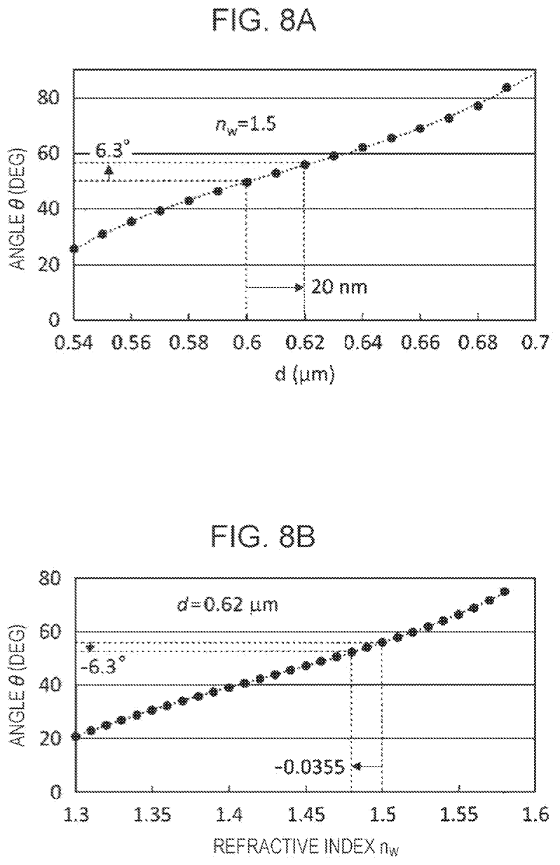

In order for the aforementioned condition to be satisfied, the refractive index of each of the plurality of portions of the optical waveguide layer 20 may be adjusted in the following manner. For simplicity, an example is described in which the thickness of a first one of two portions of the optical waveguide layer 20 is given as d=600 nm and the thickness of a second one of the two portions is given as d=620 nm, FIG. 8A is a diagram showing a relationship between the thickness d of the optical waveguide layer 20 and the angle of emission θ. FIG. 8B is a diagram showing a relationship between the refractive index n_{w} of the optical waveguide layer 20 and the angle of emission θ.

As shown in FIG. 8A, when n_{w}=1.5, d=600 nm, λ=1550 nm, and m=1 in the first portion, the angle of emission of light that is emitted from the first portion is calculated from Formula (1) as θ=49.7° At this point in time, the angle of emission of light that is emitted from the second portion is given as θ=56.0°. This undesirably results in a spread of 6.3 degrees in angle of emission of emitted light between the two portions.

Accordingly, as shown in FIG. 8B, in the second portion, the refractive index is adjusted to change from n_{w}=1.5 to n_{w}=1.4645. As a result, the angle of emission of light that is emitted from the second portion is given as θ=49.7°. In this way, the angle of emission θ is held constant by applying a voltage so that the refractive index of the first portion is given as n_{w}=1.5 and applying a voltage so that the refractive index of the second portion is given as n_{w}=1.4645. This leads to a reduction in spread of a spot of emitted light.

The thickness of each of the plurality of portions of the optical waveguide layer 20 is known information that is obtained by measurement after the optical device 100 has been fabricated. According to the angle of light to be emitted and the thickness of each portion of the optical waveguide layer 20, the value of a voltage that is supplied to an electrode section that overlaps the portion is determined. For example, after the optical device 100 has been fabricated, a test may be conducted in which the angle of emission of light is measured with varied voltages being applied separately to each electrode section. Such a test makes it possible to create a database that shows a relationship between the voltage value of each electrode section and the angle of emission of light.

In the present embodiment, data showing a relationship between angles of light to be emitted and voltages to be applied separately to each of the plurality of electrode sections is stored in a memory (not illustrated). Assuming that 0 is the desired angle of emission, the voltages may be set to satisfy the condition “(n_{wk})²−(mλ/2dₖ)²=sin²θ” in all of the plurality of portions of the optical waveguide layer 20. Table 1 shows an example of the data.

TABLE 1

| | First | Second | Third | Fourth | Fifth |
|---|---|---|---|---|---|
| Angle of | electrode | electrode | electrode | electrode | electrode |
| emission | section | section | section | section | section |
| θₐ | Vₐ₁ | Vₐ₂ | Vₐ₃ | Vₐ₄ | Vₐ₅ |
| θ_{b} | V_{b1} | V_{b2} | V_{b3} | V_{b4} | V_{b5} |
| θ_{c} | V_{c1} | V_{c2} | V_{c3} | V_{c4} | V_{c5} |

In the example shown in Table 1, in a case where light is emitted at the angle of emission θₐ, voltages that are applied to the first to fifth electrode sections are Vₐ₁ to Vₐ₅, respectively. The same applies to the angle of emission θ_{b} and the angle of emission of θ_{c}. The control circuit 500 determines, with reference to the data shown in Table 1, the voltage that is applied to each of the plurality of electrode sections.

The data shown in Table 1 may be acquired, for example, in the following manner.

A screen is disposed in front of the optical device 100. Onto the screen, a spot of light emitted from the optical device 100 is projected. The control circuit 500 applies an uniform voltage component to each of the plurality of electrode sections regardless of electrode section. The angle of emission of emitted light is determined from the spot of light projected onto the screen. Next, in addition to the uniform voltage component, the control circuit 500 applies individual voltage components separately to each of the plurality of electrode sections. The control circuit 500 determines individual voltage components that minimize the spread of a spot of light that is projected onto the screen. The sum of the uniform voltage component and each of the individual voltage components is a voltage that is applied to a corresponding one of the plurality of electrode sections. This method makes it possible to acquire the data shown in Table 1 without using the mathematical formula (n_{wk})²−(mλ/2dₖ)²=sin²θ.

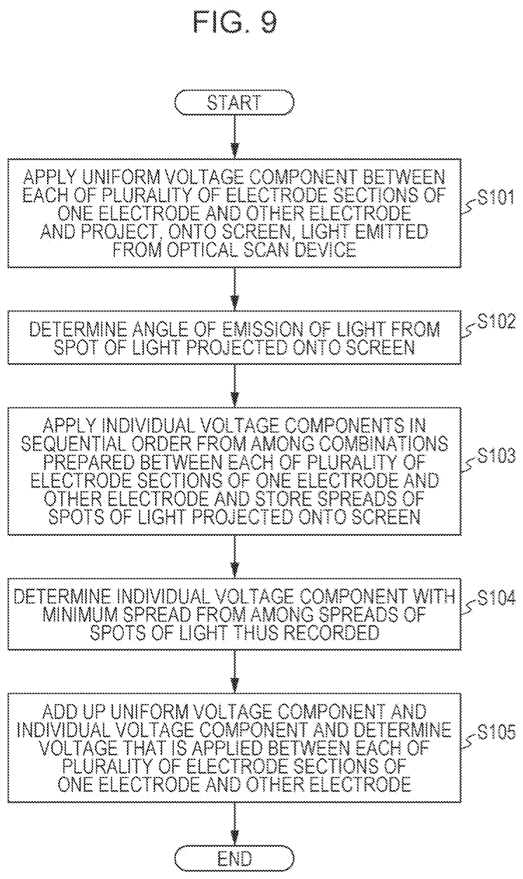

FIG. 9 is a flow chart of operation of the control circuit 500 for the acquisition of the data shown in Table 1 from a spot of light projected onto the screen.

In step 3101, the control circuit 500 applies a uniform voltage component to each of the plurality of electrode sections and projects, onto the screen, light emitted from the optical device 100.

In step S102, the control circuit 500 determines an angle of emission from the spot of light projected onto the screen.

In step S103, the control circuit 500 applies individual voltage components in a sequential order from among combinations prepared separately to each of the plurality of electrode sections and records spreads of spots of light projected onto the screen. For example, (2M+1) voltages ranging from −MΔ V to MΔ V in increments of ΔV are applied to the kth electrode section of the N electrode sections of the electrode 62 as counted from the −X direction. Note here that N and M are each an integer of 1 or larger. At this point in time, the number of combinations of individual voltages that are applied separately to each of the N electrode sections is the Nth power of (2M+1). Individual voltages that bring about a change in location of the center of a spot of light are excluded from the combinations. For example, when individual voltages that are applied separately to each of the plurality of electrode sections are all the same, there may be a change in location of the center of a spot of light.

In step S104, the control circuit 500 determines individual voltage components with a minimum spread from among the spreads of the spots of light thus recorded. The recording of the spreads of the spots of light and the determination of a spot of light with a minimum spread may involve the use of a publicly-known image authentication technology.

In step S105, the control circuit 500 adds up the uniform voltage component and each of the individual voltage components and determines a voltage that is applied to a corresponding one of the plurality of electrode sections.

Thus, the data shown in Table 1 can be acquired from the angle of emission determined in step S102 and the voltages determined in step S105.

In the aforementioned example, the control circuit 500 applies a voltage to each of the plurality of electrode sections in accordance with one control signal. Alternatively, the control circuit 500 may apply a voltage to each of the plurality of electrode sections in accordance with two control signals. In this case, the voltage that is applied to each of the plurality of electrode sections is the sum of a first voltage component and a second voltage component.

Regardless of electrode section, the control circuit 500 sets the first voltage component in accordance with a first control signal to a uniform value corresponding to the angle of emission of light that is emitted via the mirror 30.

The control circuit 500 sets the second voltage component in accordance with a second control signal to a value corresponding to the thickness of each of the plurality of portions of the optical waveguide layer 20. The first voltage component is equivalent to the aforementioned uniform voltage component, and the second voltage component is equivalent to the aforementioned individual voltage component. That is, the first voltage component is a component pertaining to the angle of emission, and the second voltage component is a component that reduces the spread of a spot of light. The control circuit 500 causes, in accordance with the first control signal and the second control signal, lights to be emitted at an identical angle of emission via the mirror 30 from the plurality of portions of the optical waveguide layer 20. This leads to a reduction in spread of a spot of emitted light.

The refractive index of the optical waveguide layer 20 may also vary with changes in temperature. In this case, the control circuit 500 may further include a temperature sensor. The control circuit 500 may correct the voltage that is applied to each of the plurality of electrode sections according to changes in temperature in accordance with a third control signal in addition to the aforementioned first control signal and the second control signal, The voltage that is applied to each of the plurality of electrode sections is the sum of the aforementioned first voltage component, the aforementioned second voltage component, and a third voltage component. Regardless of electrode section, the control circuit 500 sets the third voltage component to a uniform value corresponding to a temperature measured by the temperature sensor. The third voltage component is a component that suppresses a reduction in control accuracy resulting from temperature changes. The control circuit 500 causes, in accordance with the first to third control signals, lights to be emitted at an identical angle of emission via the mirror 30 from the plurality of portions of the optical waveguide layer 20. This leads to a reduction in change of the angle of emission resulting from temperature changes and a reduction in spread of a spot of emitted light.

Next, a modification of the optical device 100 according to the present embodiment is described.

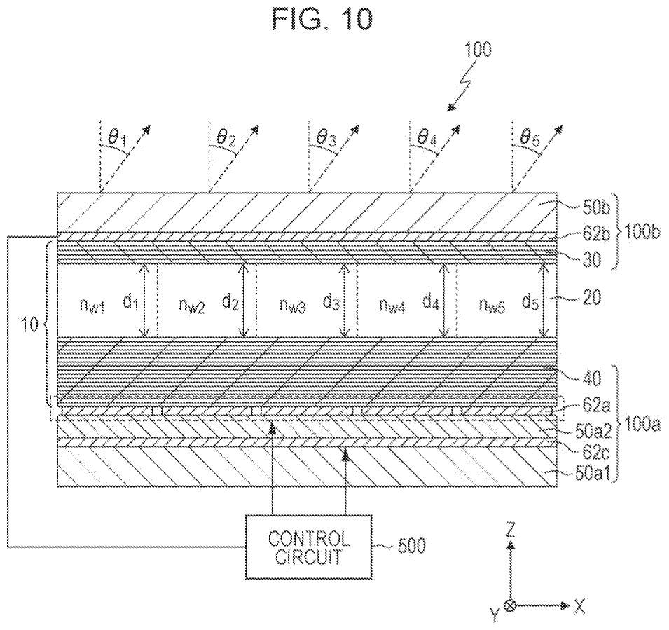

FIG. 10 is a diagram schematically showing a modification of the optical device 100 shown in FIG. 7. In the example shown in FIG. 10, the substrate 50a shown in FIG. 7 is replaced by a substrate 50a1 and a substrate 50a2 holding an electrode 62c therebetween. The electrode 62c faces the electrode 62b. The electrode 62b and the electrode 62c directly or indirectly hold the optical waveguide layer 20 therebetween. In the example shown in FIG. 10, the mirror 40, the electrode 62a, and the substrate 50a2 are located between the optical waveguide layer 20 and the electrode 62c. The control circuit 500 controls a voltage that is applied to the optical waveguide layer 20 via the electrode 62a, the electrode 62b, and the electrode 62c.

An example is described in which a voltage that is applied to each of the plurality of portions of the optical waveguide layers 20 is the sum of the aforementioned first voltage component and the aforementioned second voltage component. In the example shown in FIG. 10, the first voltage component may be applied between the electrode 62b and the electrode 62c. The second voltage component may be applied to each of the plurality of electrode sections,

The control circuit 500 sets the first voltage component in accordance with a first control signal to a value corresponding to the angle of emission of light that is emitted via the mirror 30. In the aforementioned example, the first voltage component assumes a uniform value regardless of the plurality of electrode sections, Accordingly, the first voltage component can be applied via the electrode 62b and the electrode 62c, which do not include the plurality of electrode sections.

The control circuit 500 sets the second voltage component in accordance with a second control signal to a value corresponding to the thickness of each of the plurality of portions of the optical waveguide layer 20.

The control circuit 500 causes, in accordance with the first control signal and the second control signal, lights to be emitted at an identical angle of emission via the mirror 30 from the plurality of portions of the optical waveguide layer 20. This leads to a reduction in spread of a spot of emitted light.

Next, an example is described in which a voltage that is applied to each of the plurality of portions of the optical waveguide layer 20 is the sum of the aforementioned first voltage component, the aforementioned second voltage component, and the aforementioned third voltage component. In the example shown in FIG. 10, the first voltage component and the third voltage component are applied between the electrode 62b and the electrode 62c. The second voltage component is applied to each of the plurality of electrode sections.

The control circuit 500 may further include a temperature sensor. The control circuit 500 sets the third voltage component in accordance with a third control signal to a value corresponding to a temperature measured by the temperature sensor. In the aforementioned example, the third voltage component assumes a uniform value regardless of the plurality of electrode sections. Accordingly, the third voltage component can be applied via the electrode 62b and the electrode 62c, which do not include the plurality of electrode sections. The control circuit 500 causes, in accordance with the first to third control signals, lights to be emitted at an identical angle of emission via the mirror 30 from the plurality of portions of the optical waveguide layer 20. This leads to a reduction in change of the angle of emission resulting from temperature changes and a reduction in spread of a spot of emitted light.

Next, examples of the arrangement of the plurality of electrode sections of the electrode 62a are described,

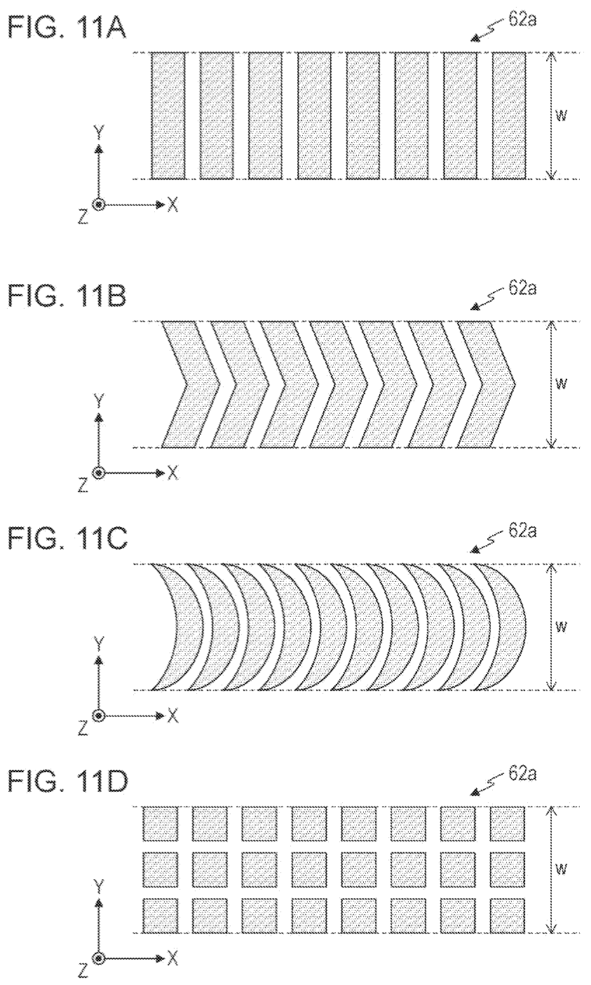

FIGS. 11A to 11D are diagrams schematically showing examples of the arrangement of the plurality of electrode sections of the electrode 62a in an XY plane. In each of the examples shown in FIGS. 11A to 11D, vv represents the width of the optical waveguide layer 20 in the Y direction.

In the example shown in FIG. 11A, the plurality of electrode sections are arranged in the X direction and are uniform in the Y direction. The length of each electrode section in the X direction and the gap between two adjacent electrode sections depend on the unevenness in thickness of the optical waveguide layer 20. When the thickness of the optical waveguide layer 20 gradually changes along the X direction, the length of each electrode section in the X direction is designed to be long and the gap between two adjacent electrode sections may be designed to be wide. Meanwhile, when the thickness of the optical waveguide layer 20 rapidly changes along the X direction, the length of each electrode section in the X direction is designed to be short and the gap between two adjacent electrode sections may be designed to be narrow. In this way, the length of each electrode section in the X direction and the gap between two adjacent electrode sections are designed as appropriate depending on the unevenness in thickness of the optical waveguide layer 20.

In each of the examples shown in FIGS. 11B and 11C, as in the case of the example shown in FIG. 11A, the plurality of electrode sections are arranged in the X direction. In each of the examples shown in FIGS. 11B and 11C, any two adjacent electrode sections of the plurality of electrode sections have overlaps with each other when seen from a position parallel to each electrode and from the Y direction. Thus, unlike in the example shown in FIG. 11A, the optical waveguide layer 20, when seen from the Y direction, has no portion to which no voltage is applied in the X direction. As a result, the influence of the gap between electrode portions can be curbed.

In the example shown in FIG. 11D, the plurality of electrode sections are arranged in a matrix in the X direction and the Y direction. The plurality of electrode sections shown in FIG. 11D are effective in a case where the thickness of the optical waveguide layer 20 is uneven not only in the X direction but also in the Y direction.

The optical device 100 according to the present embodiment may include a plurality of optical waveguide units arrayed in the Y direction, a control circuit 500, and a plurality of phase shifters.

Each of the plurality of optical waveguide units includes, for example, components shown in FIG. 7. The components are an optical waveguide element 10, a substrate 50a, the substrate 50b, an electrode 62a, and an electrode 62b. In the plurality of optical waveguide units, the mirror 30, the mirror 40, the substrate 50a, the substrate 50b, the electrode 62a, and the electrode 62b of the components shown in FIG. 7 may be configured in an integrated manner. In the plurality of optical waveguide units, a supporting member that supports the mirror 30 and the mirror 40 may be disposed between any two optical waveguide layers 20 that are adjacent to each other in the Y direction and outside optical waveguide layers 20 at both ends. The refractive index of the supporting member is lower than the refractive index of an optical waveguide layer 20. This allows light inside the optical waveguide layer 20 to propagate along the X direction without leaking in the Y direction. Each of the plurality of optical waveguide units may include components shown in FIG. 10 instead of the components shown in FIG. 7.

The plurality of phase shifters are connected to the plurality of optical waveguide units, respectively. Each of the plurality of phase shifters includes an optical waveguide joined either directly or via another optical waveguide to the optical waveguide layer 20 of a corresponding one of the plurality of optical waveguide units. By varying differences in phase among lights passing through the plurality of phase shifters, the direction of light that is emitted via the mirror 30 or, as will be mentioned later, the direction of incidence of light that is taken into the optical waveguide layer 20 via the mirror 30 is changed.

### Embodiment 2

In the aforementioned example, an example has been described in which the spread of a spot of emitted light is reduced. An optical scan device 100 according to the present embodiment may actively increase or decrease the spread of a spot of emitted light. For simplicity, it is assumed here that the thickness of the optical waveguide layer 20 is even.

The control circuit 500 may control the direction of emitted light in accordance with a first control signal and control the shape of emitted light in accordance with a second control signal. The direction of emitted light is determined, for example, by the average of the angles of emission of lights that are emitted from the plurality of portions of the optical waveguide layer 20. The shape of emitted light is determined, for example. by the difference between the maximum and minimum values of the angles of emission of lights that are emitted from the plurality of portions of the optical waveguide layer 20.

From Formula (1), the refractive index n_{w}=no that satisfies the desired angle of emission θ of emitted light is determined. The voltage that is applied to each of the plurality of electrode sections is the sum of a first voltage component and a second voltage component. The control circuit 500 applies such a first voltage component to each of the plurality of electrode sections in accordance with the first control signal that the refractive indices of the portions overlapping the plurality of electrode sections become no. The first voltage component assumes a uniform value regardless of electrode section. The control circuit 500 applies such second voltage components to the plurality of electrode sections, respectively, in accordance with the second control signal that the spread of a spot of emitted light is increased or decreased.

The second voltage components that are applied to the plurality of electrode sections assume positive or negative values. In a case where the plurality of electrode sections include M electrode sections, the angles of emission of lights that are emitted via the first mirror 30 from the portions overlapping the plurality of electrode sections are represented as θ₁ to θ_{M}, respectively. In a case where θ is the direction of emission of a light beam and Δθ is the spread angle, the refractive index of a portion overlapping the jth electrode section of the M electrode sections in the X direction is adjusted, for example, so that θⱼ=θ−(Δθ/2)+Δθ[(j−1)/(M−1)]. In this case, the maximum value of the angles of emission is given as θ_{M}=θ+Δθ/2, and the minimum value is given as θ₁=θ−Δθ/2. This is not the only combination of θ₁ to θ_{M}. With the spread angle being Δθ, any combination of θ₁ to θ_{M} is possible. In the example shown in FIG. 8B, the spread angle of a spot of emitted light is given as Δθ=6.3°, provided the refractive indices of the plurality of portions of the optical waveguide layer 20 fall within a range of n_{w1}=1.4645 to n_{wM}=1.50. The second voltage components are set so that the refractive indices n_{w} of the plurality of portions of the optical waveguide layer 20 cover the aforementioned range. The second voltage components may be set on the basis of random numbers,

In this way, the control circuit 500 controls the direction of emitted light by controlling the first voltage component in accordance with the first control signal and controls the shape of emitted light by controlling the second voltage components in accordance with the second control signal.

Independent control of the first voltage component and the second voltage components has the following advantage. In a case where the direction and shape of emitted light is controlled in accordance with one control signal, the number of control signals that are stored in a memory (not illustrated) of the control circuit 500 is the product of the number of desired directions of emission and the number of desired shapes. Meanwhile, in a case where the direction and shape of emitted light are independently controlled in accordance with two control signals, the number of control signals that are stored in the memory (not illustrated) of the control circuit 500 is the sum of the number of desired directions of emission and the number of desired shapes. Accordingly, independent control makes it possible to greatly reduce the number of data that represent control signals that are stored in the memory (not illustrated) of the control circuit 500.

### Embodiment 3

For simplicity, it has been assumed in Embodiment 2 that the thickness of the optical waveguide layer 20 is even. In actuality, the thickness of the optical waveguide layer 20 may be uneven. In this case, an optical scan device 100 according to the present embodiment may actively increase or decrease the spread of a spot of emitted light through a combination of Embodiments 1 and 2. The voltage that is applied to each of the plurality of electrode sections is the sum of a first voltage component and a second voltage component.

The first voltage component is a voltage, described in Embodiment 1, that is applied to each of the plurality of electrode sections. The first voltage component assumes a value corresponding to each of the plurality of electrode sections. The first voltage component causes light to be emitted at the same angle of emission θ separately from each of the plurality of portions of the optical waveguide layer 20.

The second voltage component is a voltage, described in Embodiment 2, that controls the shape of emitted light.

The control circuit 500 applies the first voltage component to each of the plurality of electrode sections in accordance with a first control signal and applies the second voltage component to each of the plurality of electrode sections in accordance with a second control signal. With no second voltage component applied to any of the plurality of electrode sections, the spread of emitted light is at a minimum. With the second voltage component applied to each of the plurality of electrode sections, the spread of the spot of emitted light increases from the minimum value. The optical scan device 100 according to the present embodiment can actively increase or decrease the spread of a spot of emitted light and reduce the minimum value of the spread of the spot. This makes it possible to maximize a variable range of spot sizes,

### Examples of Application

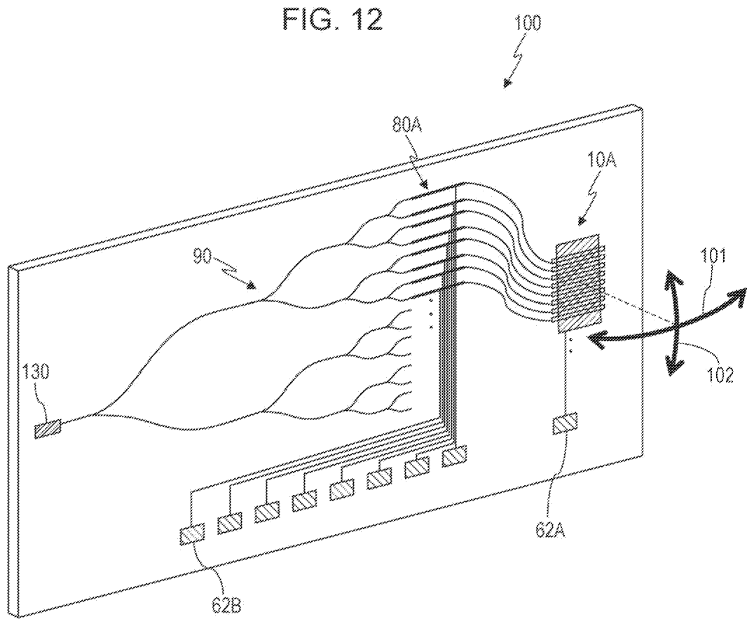

FIG. 12 is a diagram showing an example configuration of an optical scan device 100 in which elements such as an optical divider 90, an optical waveguide array 10A, a phase shifter array 80A, and a light source 130 are integrated on a circuit board (e.g. a chip). The light source 130 may for example be a light-emitting element such as a semiconductor laser. In this example, the light source 130 emits single-wavelength light whose wavelength in free space is The optical divider 90 divides the light from the light source 130 into lights and introduces the lights into optical waveguides of the plurality of phase shifters 80. In the example shown in FIG. 12, there are provided an electrode 62A and a plurality of electrodes 62B on the chip. The optical waveguide array 10A is supplied with a control signal from the electrode 62A. To the plurality of phase shifters 80 in the phase shifter array 80A, control signals are sent from the plurality of electrodes 62B, respectively. The electrode 62A and the plurality of electrodes 62B may be connected to a control circuit (not illustrated) that generates the control signals. The control circuit may be provided on the chip shown in FIG. 12 or may be provided on another chip in the optical scan device 100.

As shown in FIG. 12, an optical scan over a wide range can be achieved through a small-sized device by integrating all components on the chip. For example, all of the components shown in FIG. 12 can be integrated on a chip measuring approximately 2 mm by 1 mm.

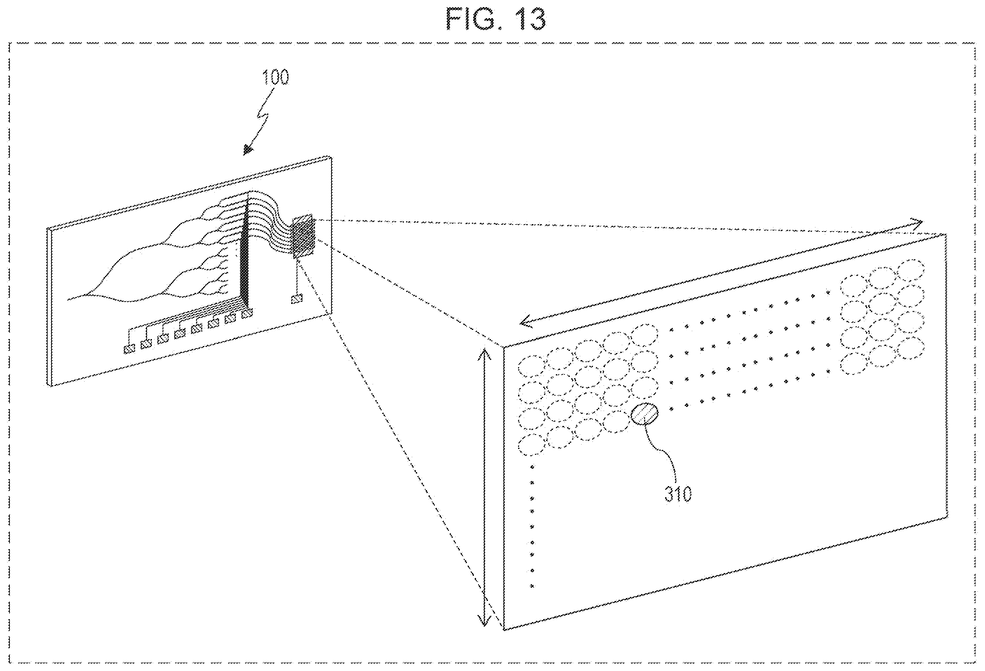

FIG. 13 is a schematic view showing how a two-dimensional scan is being executed by irradiating a distant place with a light beam such as a laser from the optical scan device 100. A two-dimensional can is executed by moving a beam spot 310 in horizontal and vertical directions. For example, a two-dimensional ranging image can be acquired by a combination with a publicly-known TOF method. The TOF method is a method for, by observing light reflected from a physical object irradiated with a laser, calculating the time of fight of the light to figure out the distance.

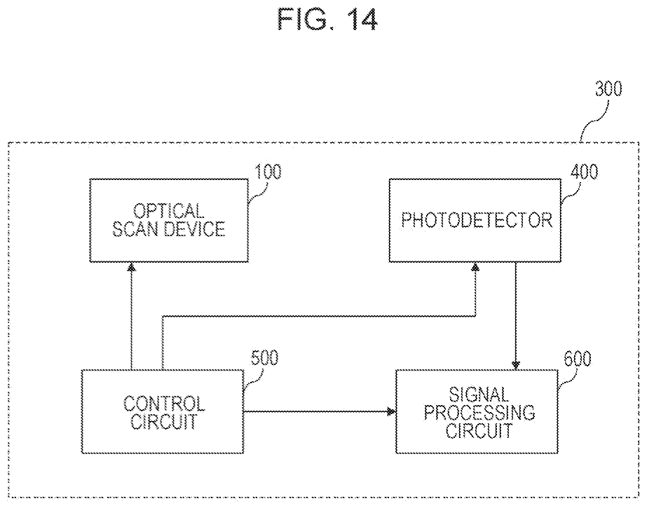

FIG. 14 is a block diagram showing an example configuration of a LiDAR system 300 serving as an example of a photodetection system that is capable of generating such a ranging image. The LiDAR system 300 includes an optical scan device 100, a photodetector 400, a signal processing circuit 600, and a control circuit 500. The photodetector 400 detects light emitted from the optical scan device 100 and reflected from a physical object. The photodetector 400 may for example be an image sensor that has sensitivity to the wavelength of light that is emitted from the optical scan device 100 or a photodetector including a photo-sensitive element such as a photodiode. The photodetector 400 outputs an electrical signal corresponding to the amount of light received. The signal processing circuit 600 calculates the distance to the physical object on the basis of the electrical signal outputted from the photodetector 400 and generates distance distribution data. The distance distribution data is data that represents a two-dimensional distribution of distance (i.e. a ranging image). The control circuit 500 is a processor that controls the optical scan device 100, the photodetector 400, and the signal processing circuit 600. The control circuit 500 controls the timing of irradiation with a light beam from the optical scan device 100 and the timing of exposure and signal readout of the photodetector 400 and instructs the signal processing circuit 600 to generate a ranging image.

The frame rate at which a ranging image is acquired by a two-dimensional scan can be selected, for example, from among 60 fps, 50 fps, 30 fps, 25 fps, 24 fps, or other frame rates, which are commonly used to acquire moving images. Further, in view of application to an onboard system, a higher frame rate leads to a higher frequency of acquisition of a ranging image, making it possible to accurately detect an obstacle. For example, in the case of a vehicle traveling at 60 km/h, a frame rate of 60 fps makes it possible to acquire an image each time the vehicle moves approximately 28 cm. A frame rate of 120 fps makes it possible to acquire an image each time the vehicle moves approximately 14 cm. A frame rate of 180 fps makes it possible to acquire an image each time the vehicle moves approximately 9.3 cm.

The time required to acquire one ranging image depends on the speed of a beam scan. For example, in order for an image whose number of resolvable spots is 100 by 100 to be acquired at 60 fps, it is necessary to perform a beam scan at 1.67 μs or less per point. In this case, the control circuit 500 controls the emission of a light beam by the optical scan device 100 and the storage and readout of a signal by the photodetector 400 at an operating speed of 600 kHz.

### Example of Application to Optical Receiver Device

Each of the optical scan devices according to the aforementioned embodiments of the present disclosure can also be used as an optical receiver device of similar configuration. The optical receiver device includes an optical waveguide array 10A which is identical to that of the optical scan device and a first adjusting element that adjusts the direction of light that can be received. Each of the first mirrors 30 of the optical waveguide array 10A transmits light falling on a side thereof opposite to a first specular surface from the third direction. Each of the optical waveguide layers 20 of the optical waveguide array 10A causes the light transmitted through the first mirror 30 to propagate in the second direction. The direction of light that can be received can be changed by the first adjusting element changing at least one of the refractive index of the optical waveguide layer 20 of each optical waveguide element 10, the thickness of the optical waveguide layer 20 of each optical waveguide element 10, or the wavelength of light. Furthermore, in a case where the optical receiver device includes a plurality of phase shifters 80 or 80a and 80b which are identical to those of the optical scan device and a second adjusting element that varies differences in phase among lights that are outputted through the plurality of phase shifters 80 or 80a and 80b from the plurality of optical waveguide elements 10, the direction of light that can be received can be two-dimensionally changed.

For example, an optical receiver device can be configured such that the light source 130 of the optical scan device 100 shown in FIG. 12 is substituted by a receiving circuit. When light of wavelength λ falls on the optical waveguide array 10A, the light is sent to the optical divider 90 through the phase shifter array 80A, is finally concentrated on one place, and is sent to the receiving circuit. The intensity of the light concentrated on that one place can be said to express the sensitivity of the optical receiver device. The sensitivity of the optical receiver device can be adjusted by adjusting elements incorporated separately into the optical waveguide array 10A and the phase shifter array 80A, The optical receiver device is opposite in direction of the wave number vector (in the drawing, the bold arrow) shown, for example, in FIG. 4. Incident light has a light component acting in the direction (in the drawing, the X direction) in which the optical waveguide elements 10 extend and a light component acting in the array direction (in the drawing, the Y direction) of the optical waveguide elements 10. The sensitivity to the light component acting in the X direction can be adjusted by the adjusting element incorporated into the optical waveguide array 10A. Meanwhile, the sensitivity to the light component acting in the array direction of the optical waveguide elements 10 can be adjusted by the adjusting element incorporated into the phase shifter array 80A. θ and α₀ shown in FIG. 4 are found from the phase difference Δφ of light and the refractive index n_{w} and thickness d of the optical waveguide layer 20 at which the sensitivity of the optical receiver device reaches its maximum. This makes it possible to identify the direction of incidence of light.

The aforementioned embodiments may be combined as appropriate.

An optical scan device and an optical receiver device according to an embodiment of the present disclosure are applicable, for example, to a use such as a LiDAR system that is mounted on a vehicle such as an automobile, a UAV, or an AGV.

What is claimed is:

1. An optical device comprising:
a first mirror extending in a first direction;
a second mirror facing the first mirror and extending in the first direction;
an optical waveguide layer, located between the first mirror and the second mirror, that propagates light along the first direction and that contains a material whose refractive index changes when a voltage is applied;
first and second electrodes directly or indirectly holding the optical waveguide layer therebetween, the first electrode including a plurality of electrode sections arranged in the first direction; and
a control circuit that controls a voltage that is applied between each of the plurality of electrode sections of the first electrode and the second electrode,
wherein
the light is emitted via the first mirror from the optical waveguide layer, or
the light is taken into the optical waveguide layer via the first mirror.

2. The optical device according to claim 1, wherein the control circuit sets a value of the voltage that is applied between each of the plurality of electrode sections and the second electrode to such a value that lights are emitted at an identical angle of emission from a plurality of portions of the optical waveguide layer that overlap the plurality of electrode sections, respectively, when seen from a direction perpendicular to the first mirror.

3. The optical device according to claim 1, wherein when it is assumed that n_{wk} is a refractive index of a portion of the optical waveguide layer that overlaps a kth (where k is an integer of 2 or larger) electrode section of the plurality of electrode sections, dₖ is a thickness of the portion, λ is a wavelength in air of light propagating through the optical waveguide layer, and m is a mode number of light propagating through the optical waveguide layer, the control circuit sets a value of the voltage that is applied between each of the plurality of electrode sections and the second electrode to such a value that all of the plurality of portions of the optical waveguide layer become equal in (n_{wk})²−(mλ/2dₖ)².

4. The optical device according to claim 1, wherein the control circuit determines, with reference to data showing an angle of emission of light and the voltage that is applied between each of the plurality of electrode sections of the first electrode and the second electrode, a value of the voltage that is applied between each of the plurality of electrode sections of the first electrode and the second electrode.

5. The optical device according to claim 1, wherein
the voltage that is applied between each of the plurality of electrode sections and the second electrode is a sum of a first voltage component and a second voltage component,
the control circuit sets the first voltage component regardless of electrode section to a uniform value corresponding to an angle of emission of the light that is emitted via the first mirror, and
the control circuit sets the second voltage component to a value corresponding to each of the plurality of portions of the optical waveguide layer.

6. The optical device according to Claim , further comprising a temperature sensor,
wherein the control circuit sets the voltage that is applied between each of the plurality of electrode sections and the second electrode to a value corresponding to a temperature measured by the temperature sensor.

7. The optical device according to claim 1, further comprising a third electrode facing the second electrode across the optical waveguide layer.

8. The optical device according to claim 7, further comprising a temperature sensor,
wherein the control circuit sets a voltage that is applied between the second electrode and the third electrode to a value corresponding to a temperature measured by the temperature sensor.

9. The optical device according to claim 1, wherein any two adjacent electrode sections of the plurality of electrode sections have overlaps with each other when seen from a position parallel to a surface of each electrode section and from a direction orthogonal to the first direction.

10. The optical device according to claim 1, wherein the plurality of electrode sections are arranged in the first direction and a second direction that intersects the first direction.

11. The optical device according to claim 1, wherein the optical waveguide layer contains a liquid crystal material or an electro-optical material.

12. The optical device according to claim 1, wherein the control circuit controls the voltage that is applied between each of the plurality of electrode sections and the second electrode and thereby controls a direction and shape of the light that is emitted via the first mirror from the optical waveguide layer.

13. The optical device according to claim 1, further comprising a plurality of optical waveguide units, arrayed in a second direction that intersects the first direction, each of which includes the first mirror, the second mirror, the optical waveguide layer, and the first and second electrodes.

14. The optical device according to claim 13, further comprising a plurality of phase shifters, connected separately to each of the plurality of optical waveguide units, each of which includes an optical waveguide joined either directly or via another optical waveguide to the optical waveguide layer of a corresponding one of the plurality of optical waveguide units,
wherein a direction of the light that is emitted via the first mirror from the optical waveguide layer or a direction of incidence of the light that is taken into the optical waveguide layer via the first mirror is changed by varying differences in phase among lights passing through the plurality of phase shifters.

15. A photodetection system comprising:
the optical device according to claim 1;
a photodetector that detects light emitted from the optical device and reflected from a physical object; and
a signal processing circuit that generates distance distribution data on the basis of output from the photodetector.
